(19) United States
(12) Patent Application Publication
(10) Pub. No.: US 2002/0180980 A1
(43) Pub. Date: Dec. 5, 2002

(54) Optical signal interleaver and deinterleaver devices with chromatic dispersion compensation

(76) Inventor: Shijie Gu, Sunnyvale, CA (US)

Correspondence Address: ANTHONY G. DERVAN, LUMEN INTELLECTUAL PROPERTY SERVICES, 45 CABOT AVENUE, SUITE 110, SANTA CLARA, CA, 95051, US

(21) Appl. No.: 09/874,925

(22) Filed: Jun. 4, 2001

(51) Int. Cl. G01B 9/02

(52) U.S. Cl. 356/491

(57) ABSTRACT

A dispersion compensated optical signal interleaver having GTI based interferometer for interleaving and deinterleaving sets of odd and even channels and having an additional GTI interferometer for compensating the chromatic dispersion arising from the first interferometer.

### FIELD OF THE INVENTION

This invention relates generally to dense wavelength division multiplexed (DWDM) optical communications systems. More particularly the invention relates to interface devices such as interleavers and deinterleavers for use in interfacing between portions of DWDM systems operating at channels spacing differing by a factor of two, between, for example, portions using 50 GHz per channel spacing and portions using 100 GHz per channel spacing.

### BACKGROUND OF THE INVENTION

As DWDM optical communications technology has progressed, the channel spacing has decreased over a number of years from 200 GHz to 100 GHz to 50 GHz per channel. When a communications system is being upgraded from say 100 GHz per channel to 50 GHz per channel, it may be expedient to retain some older equipment in the system, e.g., older equipment that was designed for operation at 100 GHz per channel. The older equipment can be retained in the upgraded system by using interleavers and deinterleavers to interface between the two generations of equipment.

An interleaver combines an optical signal containing even channels with an optical signal containing odd channels. A 50 GHz interleaver, for example, combines an optical signal containing a set of even channels having 100 GHz channel spacing with an optical signal containing a set of odd channels having 100 Ghz spacing and produces an output optical signal containing both sets of channels and having 50 GHz channel spacing.

A deinterleaver reverses the process of the interleaver. A 50 GHz deinterleaver, for example, receives a signal containing both a set of even channels and a set of odd channels combined and having 50 GHz channel spacing, and separates the set of even channels from the set of odd channels to produce an output signal containing the set of even channels having 100 GHz channel spacing and a separate output signal containing the set of odd channels and having 100 GHz channel spacing.

The general principle of the interleaver is an interferometric overlap of two light beams. The interference creates a periodic, repeating output as different integral multiples of wavelength pass through the device and the desired channel spacing of the interleaver is set by controlling the fringe pattern. Manufacturers today use fused-fiber Mach-Zehnder interferometers, liquid crystals, birefringent crystals, Gires-Tournois interferometers (GTI) and other devices to build interleavers.

Of these, the GTI based interleaver has many advantages over the rest. For example, a GTI based interleaver has very low insertion loss, has uniform response over a wide range of wavelengths (flat-top spectrum), and has minimal polarization dependence effect.

Chromatic dispersion must be considered for 10 Gbit/s and next generation 40 Gbit/s systems. Chromatic dispersion requirements for the higher bit rate systems are extremely tight. While there are currently many technologies being pursued for use in interleaver products, the dispersion performance will probably be the critical factor determining which technology will be successful. To be successful, the interleaver must not only have a low dispersion value at the center ITU wavelength, but over the full useful passband of the device (i.e. the dispersion should not reduce the usable passband). Unfortunately, the GTI based interleaver has a very large dispersion of up to 70-200 ps/nm for a 50 GHz interleaver and up to 250-800 ps/nm for a 25 GHz interleaver.

U.S. Pat. No. 6,169,604, issued to Cao, discloses a polarization splitting interferometer and an interleaver based on that interferometer. The interferometer is a Gires-Tournois interferometer, with the addition of λ/4 wave-plate between the mirrors and an external λ/8 wave-plate (FIGS. 8 and 9 in the referenced patent). The interleaver consists of a polarization beam splitter and two of these interferometers. This interleaver operates as an interleaver and as a deinterleaver, or in other words, this interleaver performs the two functions of an interleaver and may be called an interleaver/deinterleaver. In both modes of operation the interferometers alter the polarization of the even channels, while leaving the polarization of the odd channels unchanged (FIGS. 10, 11, and 12 in the referenced patent).

The phase of the output signals from this interleaver is

$$θ = - {tan}^{- 1} [ [ ( 1 + √ R ) / ( 1 - √ R ) ] tan ( 2 π L / λ ) - π / 4 ] - {tan}^{- 1} [ [ ( 1 + √ R ) / ( 1 - √ R ) tan ( 2 π L / λ ) + π / 4 ) ] \qquad ( 1 )$$

FIG. 1 shows the group delay and FIG. 2 shows the dispersion as calculated for a 50 GHz interleaver/deinterleaver of the above type, using the following parameters; reflectivity R=18.5% and Length L=1.5 mm. From FIG. 2, the dispersion is +/−60 ps/nm in bandwidth +/−0.11 nm (+/−14 GHz).

U.S. Pat. No. 6,169,626, issued to Chen et al., discloses an interleaver/ deinterleaver that use a Gires-Tournois-Michelson interferometer (GTMI). The dispersion of a 50 GHz GTMI is calculated by the present inventor to +/−50 ps/nm in the bandwidth +/−10 GHz.

Neither of the above references disclose any way of compensating the rather large chromatic dispersion associated with the GTI based interferometers.

An interleaver with such high dispersion is not useful in a high bit rate system. Therefore, there exists a need for a compensation mechanism that would reduce the dispersion of the GTI based interleaver to such a range that the GTI based interleaver becomes a useful device. The present invention addresses this need.

### OBJECTS AND ADVANTAGES

It is an object of the present invention to provide an optical signal interleaver and an optical signal deinterleaver that have a much reduced level of chromatic dispersion.

It is a further object of the present invention to provide an optical signal interleaver and an optical signal deinterleaver that are suitable for use in 50 GHz DWDM systems.

It is a further object of the present invention to provide an optical signal interleaver and an optical signal deinterleaver that do not require the use of an optical circulator.

### SUMMARY

The objects and advantages of the present invention are secured by providing dispersion compensation in a GTI based interleaver and also by providing dispersion compensation in a GTI based deinterleaver. In both the interleaver and the deinterleaver the dispersion compensation is provided by a compensating interferometer that is a GTI interferometer.

The dispersion compensated interleaver of the present invention includes in its structure a signal processing interferometer and a dispersion compensating interferometer. In the interleaver, the signal processing interferometer performs the function of combining an input signal that contains a set of even channels with an input signal that contains a set of odd channels. The paths of the optical signals through the dispersion compensated interleaver are as follows: the two input signals, one containing a set of even channels and one containing a set of odd channels, are inputted to the signal processing interferometer. The signal processing interferometer combines the input signals and outputs a signal containing both sets of channels. The output signal from the signal processing interferometer is routed to the dispersion compensating interferometer where the chromatic dispersion introduced by the signal processing interferometer is compensated. The output of the dispersion compensating interferometer is the output of the interleaver. essentially all of the light in the ouput signal has been through the signal processing interferometer and through the dispersion compensating interferometer.

The dispersion compensated deinterleaver of the present invention includes in its structure a signal processing interferometer and a dispersion compensating interferometer. In the deinterleaver the signal processing interferometer performs the function of receiving an input signal containing a set of even channels and a set of odd channels and outputting two separate output signals, one output signal containing the set of odd channels and the other output signal containing the set of even channels. The paths of the optical signals through the dispersion compensated deinterleaver are as follows: the input signal containing a set of even channels and a set of odd channels passes through the dispersion compensating interferometer, where dispersion compensation is applied, and goes to the signal processing interferometer which outputs separate signals one containing the set of even channels and one containing the set of odd channels. all of the light in the output signals passed through the signal processing interferometer and through the dispersion compensation interferometer.

In one embodiment of the invention, in both the interleaver and the deinterleaver, the signal processing interferometer is a GTI based non-linear interferometer (NLI). This is a GTI interferometer with an internal λ/4 wave-plate and an external λ/8 wave-plate and operates as a polarization splitting interferometer. The NLI changes the polarization of linearly polarized even channels from vertical to horizontal or from horizontal to vertical, while leaving the polarization of linearly polarized odd channels unchanged. The NLI signal processing interferometer receives signals from a polarization beam splitter and sends output signals back to the polarization beam splitter.

In this embodiment there is one structural difference between the interleaver and the deinterleaver.

The structural difference is this. In the deinterleaver an optical component that consists of a 22.5° cut half-wave plate with a garnet is located in the optical path between the signal processing interferometer and the dispersion compensating interferometer. A horizontally polarized input signal passes through the half-wave plate and then through the garnet towards the signal processing interferometer with horizontal polarization unchanged, whereas the polarization of the horizontally polarized odd channel output signal that returns along the same path from the signal processor is changed to vertically polarized, thus allowing the odd channel output signal to be reflected to the deinterleaver output by a polarization beam splitter.

In the interleaver, on the other hand, the respective positions of the half-wave plate and the garnet are interchanged so that a vertically polarized odd channel input signal is changed to a horizontally polarized input signal as it approaches the signal processing interferometer and so that the horizontally polarized signal returning from the signal processing interferometer along the same path retains its polarization unchanged.

The effect just described that is obtained by interchanging the positions of the the 22.5° half-wave plate and the garnet can also be obtained by reversing the orientation of the garnet.

The difference in structure between interleaver and deinterleaver applies also the following embodiment of the invention.

In this embodiment of the invention, in both the interleaver and the deinterleaver, the signal processing intereferometer is a combination of a GTI and a Michelson interferometer (GTMI) where the GTI replaces one of the mirrors of a Michelson interferometer.The dispersion compensation interferometer is a GTI interferometer as before.

The interleaver of the invention has separate input/output ports so that an optical circulator is not required.

### BRIEF DESCRIPTION OF THE FIGURES

FIG. 1 is a graph showing the group delay for a 50 GHz interleaver.

FIG. 2 is a graph showing the dispersion for a 50 GHz interleaver.

FIG. 3 is a schematic diagram showing a deinterleaver in a first embodiment in accordance with the present invention.

FIG. 4 shows a dispersion compensator as used in the deinterleavers of FIG. 3 and FIG. 10.

FIG. 5 is a graph showing the group delay of the dispersion compensator of FIG. 4.

FIG. 6 shows in cross-section, a nonlinear interferometer (NLI) as used in the interleaver and the deinterleaver of the first embodiment of the invention.

FIG. 7 shows the relationship of polarization direction to c axis for the 22.5° cut half-wave plate.

FIG. 8 shows a graph of group delay for a 50 GHz dispersion compensated deinterleaver as calculated for the first embodiment shown in FIG. 3.

FIG. 9 shows a graph of the dispersion characteristic of a 50 GHz dispersion compensated deinterleaver as calculated for the first embodiment shown in FIG. 3.

FIG. 10 shows a schematic diagram of an interleaver in accordance with the present invention.

FIG. 11 shows a portion of a deinterleaver showing the arrangement of a garnet and a quarter wave plate.

FIG. 12 shows a portion of an deinterleaver showing the orientation of the garnet 32.

FIG. 13 shows, in schematic form, a deinterleaver in a second embodiment in accordance with the invention.

### DETAILED DESCRIPTION

FIG. 3 shows a schematic diagram of a deinterleaver 10 in accordance with the present invention. The deinterleaver 10 receives an input signal at input port 12. The input signal contains a set of even channels and a set of odd channels, the channel spacing being fixed at, for example, 50 GHz between alternating even and odd channels. Thus, in this example, the spacing between even channels is 100 GHz, and the spacing between odd channels is 100 GHz. A collimator 14 passes the input signal to a translator 16.

The translator 16 includes a walk-off crystal 18 and a half-wave plate 20. The input signal passes through the walk-off crystal 18 and emerges from the walk-off crystal 18 as two separate beams, a vertically polarized beam and a horizontally polarized beam. The horizontally polarized beam passes through a half-wave plate 20 and emerges from the half-wave plate 20 as a vertically polarized beam. Thus the input is translated by the translator 16 into a vertically polarized input signal consisting of two parallel beams, each vertically polarized. The translator 16 outputs this vertically polarized input signal to a polarization beam splitter 22.

The translator 16 can be operated in the reverse direction to remove polarization from an output signal. The translator described above adds and removes vertical polarization. A translator for adding and removing horizontal polarization is similar but has the half-wave plate intercepting the other beam. The term translator as used in this application is intended to include any device that performs the functions just described.

The polarization beam splitter 22 reflects the vertically polarized input signal to a quarter wave plate 24. The polarized input signal passes through the quarter-wave plate 24, the polarization of the input signal being transformed to a circular polarization by the quarter-wave plate 24. The circularly polarized input signal then goes to a dispersion compensating interferometer 26.

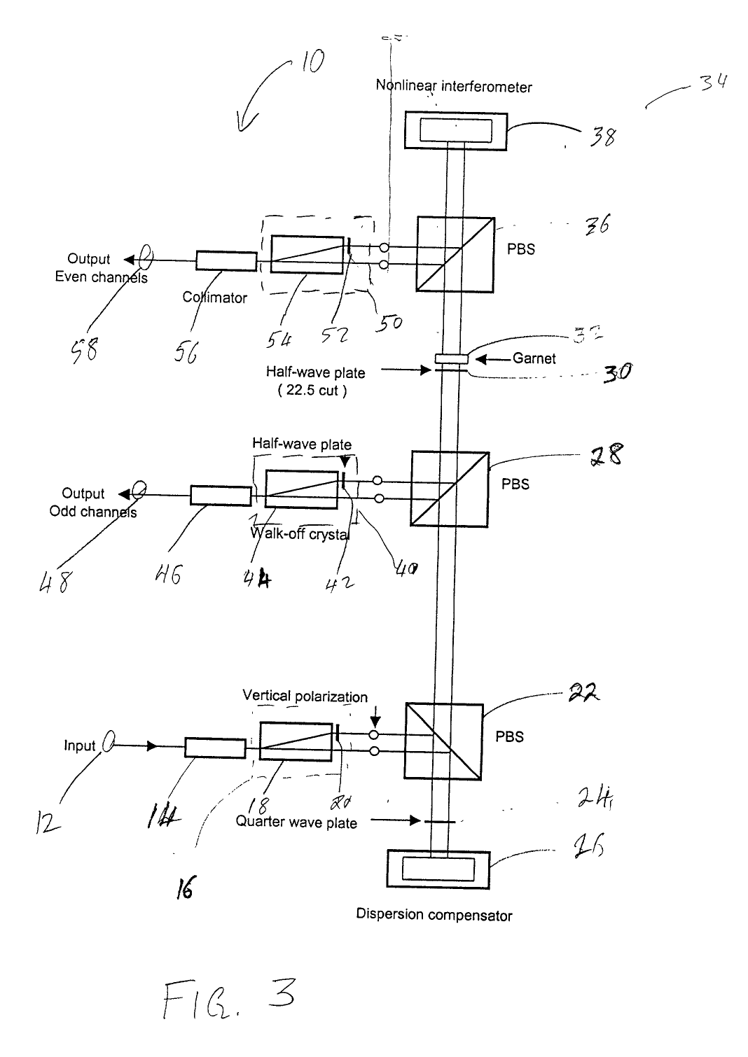

The dispersion compensating interferometer 26 is a Gires-Tournois interferometer (GTI) as shown in FIG. 2. The dispersion compensating interferometer 26 outputs a dispersion compensated circularly polarized input signal to the quarter-wave plate 24. The signal passes through the quarter-wave plate 24, is transformed to a horizontally polarized signal by the quarter wave plate 24, and emerges from the quarter-wave plate 24 as a dispersion compensated horizontally polarized input signal.

The horizontally polarized input signal is transmitted through the polarization beam splitter 22, then through another polarization beam splitter 28, then through a 22.5° cut half-wave plate 30 which rotates the polarization through forty five degrees positive, and then through a garnet 32 which rotates the polarization through forty five degrees negative. The input signal as it emerges from the garnet 32 remains a horizontally polarized input signal.

The horizontally polarized input signal then enters the interferometer section 34 of the interleaver 10. The interferometer section 34 includes a polarization beam splitter 36 and a the signal processing interferometer which in this embodiment of the invention is a nonlinear interferometer NLI 38. The nonlinear interferometer 38 in this embodiment of the invention is a modified GTI interferometer as shown in FIG.4. The horizontally polarized input signal is transmitted through the polarization beam splitter 36 to the nonlinear interferometer 38. The nonlinear interferometer 38 outputs a signal to the polarization beam splitter 36 which transmits a horizontally polarized signal containing the set of odd channels (horizontally polarized odd channel signal) and reflects a vertically polarized signal containing the set of even channels (vertically polarized even channel signal).

The horizontally polarized odd channel signal passes from the polarization beam splitter 36 out of the interferometer section 34 and through the garnet 32 which rotates the polarization forty five degrees, through the 22.5° degree cut half-wave plate 30 which rotates the polarization another forty five degrees and outputs a vertically polarized odd channel signal to the polarization beam splitter 28 where it is reflected to translator 40.

The translator 40 receives the vertically polarized odd channel signal, removes the polarization and outputs the odd channel signal. Translator 40 includes a half-wave plate 42 and a walk-off crystal 44. A part of the vertically polarized odd channel signal enters the walk-off crystal 44 directly and a part passes through the half-wave plate 42 before entering the walk-off crystal 44, the latter part becoming horizontally polarized. The vertically polarized part and the horizontally polarized part are recombined in the walk-off crystal 44 and outputted from translator 40 as the odd channel output signal which then passes through the collimator 46 to the output port 48.

Referring back to the vertically polarized even channel signal that was reflected by the polarization beam splitter 36, that signal goes to translator 50. The translator 50 includes a half-wave plate 52 and a walk-off crystal 54 and removes polarization from the polarized even channel signal just as translator 40 does for the odd channel signal. The depolarized even channel signal passes from the translator 50 through a collimator 56 to output port 58.

FIG. 4 shows a schematic cross-section of a dispersion compensating interferometer 60 that is suitable for use as a dispersion compensator in the present invention. The dispersion compensator 60 is a Gires-Tournois interferometer having a first partially reflective mirror 62 spaced apart from and parallel to a highly reflective mirror 64, with a cavity 66 between the two mirrors. The partially reflective mirror 62 provides a single input/output port 68 to allow light to enter and leave the cavity 66. The optional spacers 70 are made of ultra-low expansion material. The amplitude response of the Gires-Tournois interferometer is flat (i.e. independent of wavelength),

the phase response is

φ(λ)=2 tan⁻¹[[(1+√R)/(1−√R)]tan(2πd/λ)], (2)

the group delay is

τ(λ)=0.01λ²/6π[dφ(λ)/dλ] (ps), (3)

and the dispersion is

D(λ)=10⁻³dτ(λ)/dλ (ps/nm). (4)

In the above equations λ is wavelength, R is the power reflectivity of the partially reflective mirror, and d is the length of the cavity 66 from the partially reflective mirror 62 to the highly reflective mirror 64. The reflectivity of the highly reflective mirror is preferably about 100%.

FIG. 5 shows a graph of group delay calculated for a Gires-Tournois interferometer dispersion compensator, having a cavity length d=3 mm and reflectivity R=0.28% for the partially reflective mirror.

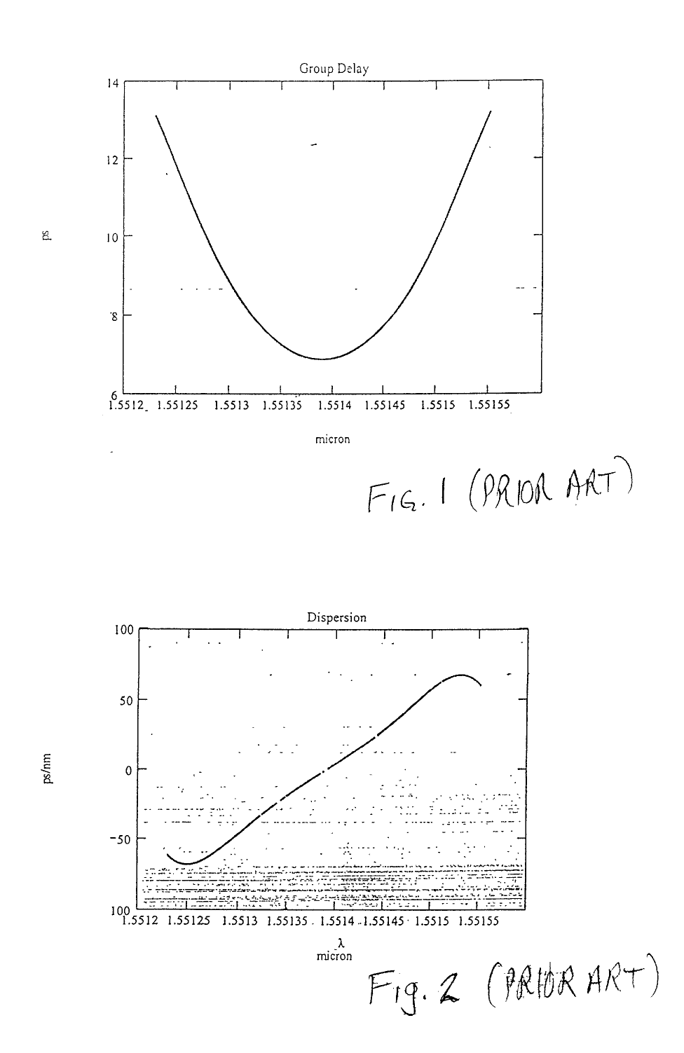

FIG. 6 shows, in cross section, a nonlinear interferometer suitable for use as the nonlinear interferometer 36 in FIG. 1. The nonlinear interferometer 100 is a modified GTI interferometer having a first partially reflective mirror 62, spaced apart from and parallel to a highly reflective mirror 64 with a cavity 66 between the two mirrors. The partially reflective mirror 62 provides a single input/output port 68 to allow light to enter and leave the cavity 66. The partially reflective mirror has a reflectivity preferably of approximately 18.5%. The highly reflective mirror preferably has reflectivity of approximately 100%.

A quarter-wave plate 70 is located in the cavity 66 and introduces a 180° round trip phase change between an o beam and an e beam of the signal inside the cavity 66. The external λ/8 plate 72 introduces a round trip phase change of π/2 between the o beam and the e beam.

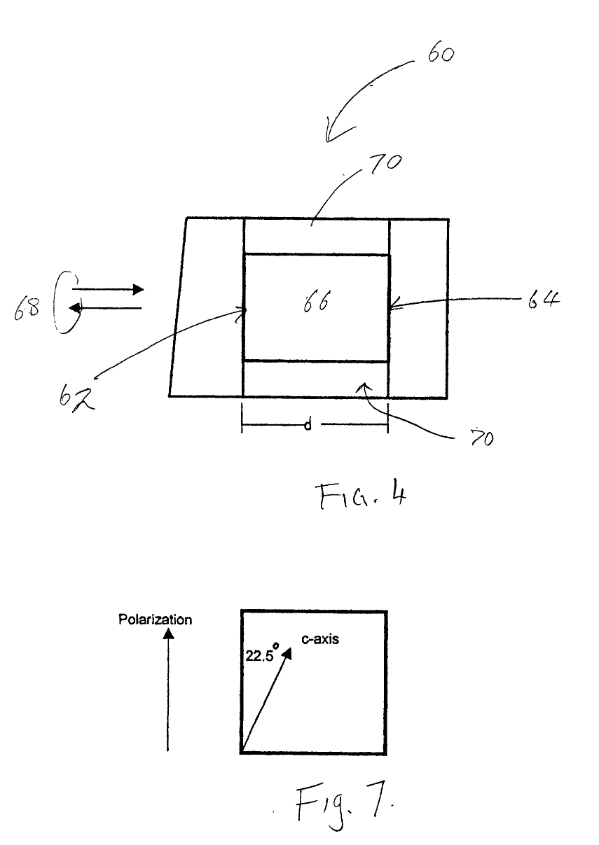

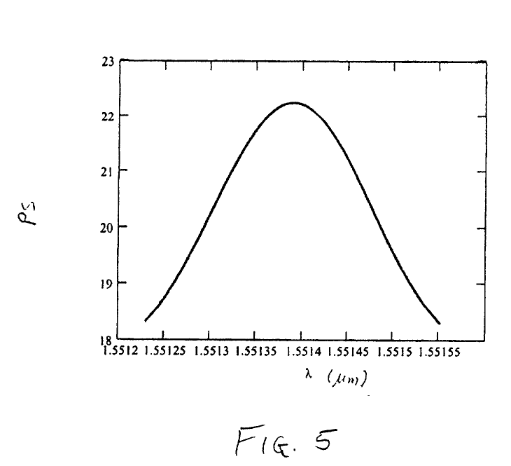

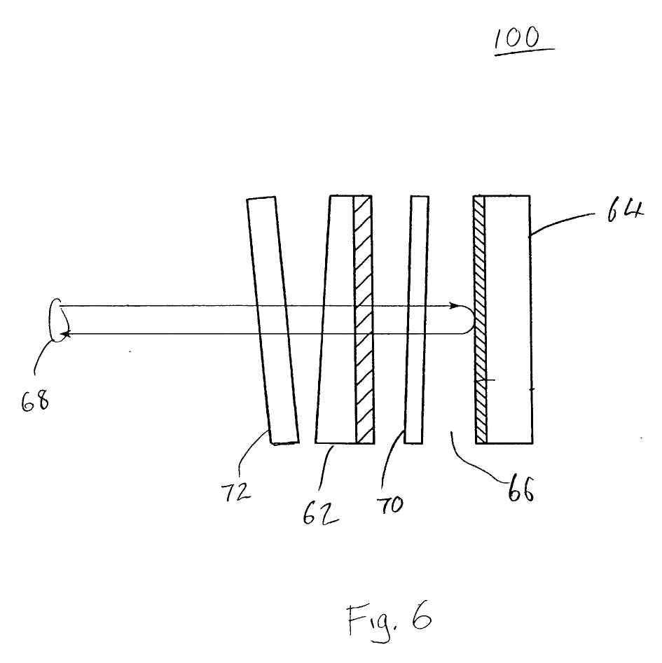

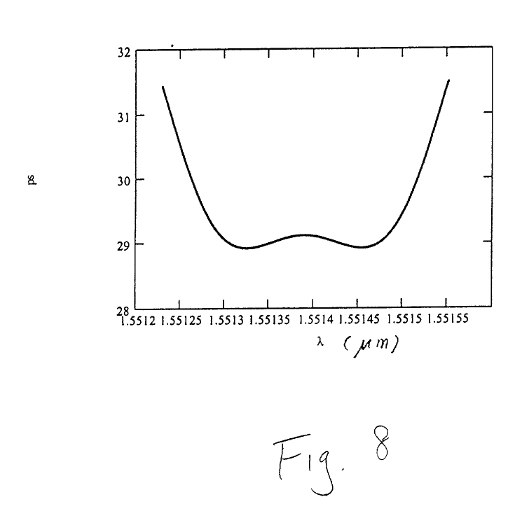

FIG. 7 shows the relationship between polarization direction and the c axis of 22.5° cut half-wave plate as used in the first and second embodiments of the invention.

FIG. 8 shows a graph of group delay for a 50 GHz dispersion compensated interleaver and deinterleaver according to the first embodiment of the invention shown in FIG. 3

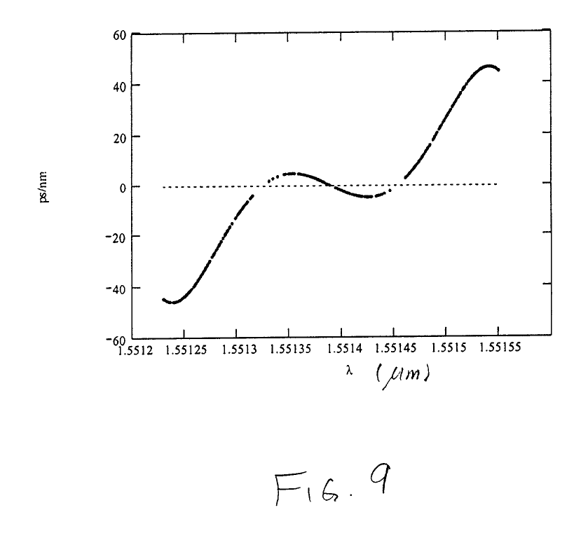

FIG. 9 shows a graph of dispersion for a 50 GHz dispersion compensated interleaver and deinterleaver according to the first embodiment shown in FIG. 3.

FIGS. 5, 8 and 9 are the results of calculations wherein the parameters were GTI cavity length=3 mm, and R=0.28%. From FIG. 9 the dispersion is only +/−4.7 ps/nm in bandwidth of +/−0.8 nm (+/−10 GHz). In order to compensate dispersion, the peak of the group delay of the compensator must be aligned with the bottom of the group delay of the interleaver.

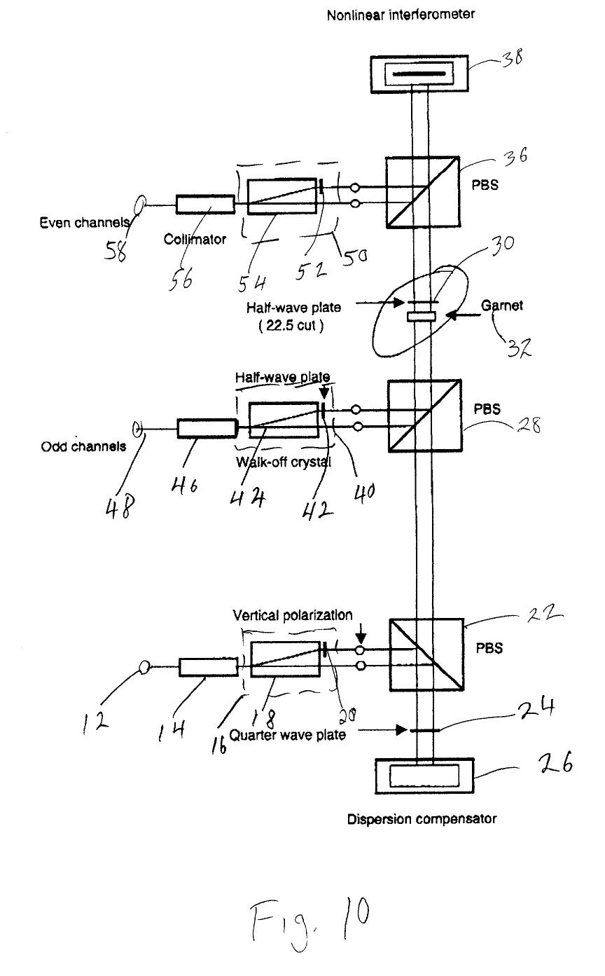

FIG. 10 shows an interleaver in accordance with the present invention. All of the elements in FIG. 10 are the same locations in FIG. 10 as in FIG. 3 except that the garnet 32 and the 22.5° cut half-wave plate 30 have changed places. In this case the odd channel input signal is changed from vertical polarization to horizontal polarization on the way to the NLI and the horizontally polarized output signal from the NLI to the dispersion compensating interferometer is not changed.

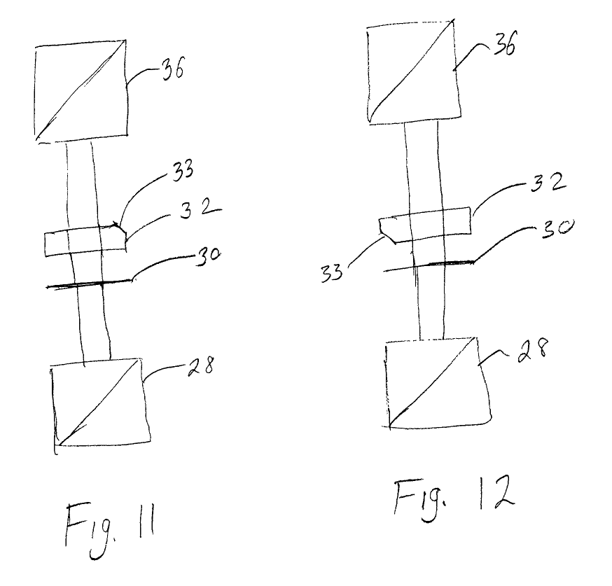

FIG. 11 shows the relevant portion of a deinterleaver that is the same as that shown in FIG. 3 except for the garnet 32 which in FIG. 11 is oriented as indicated by the facet in a specific direction, with the “A” face facing the polarization interferometer 36.

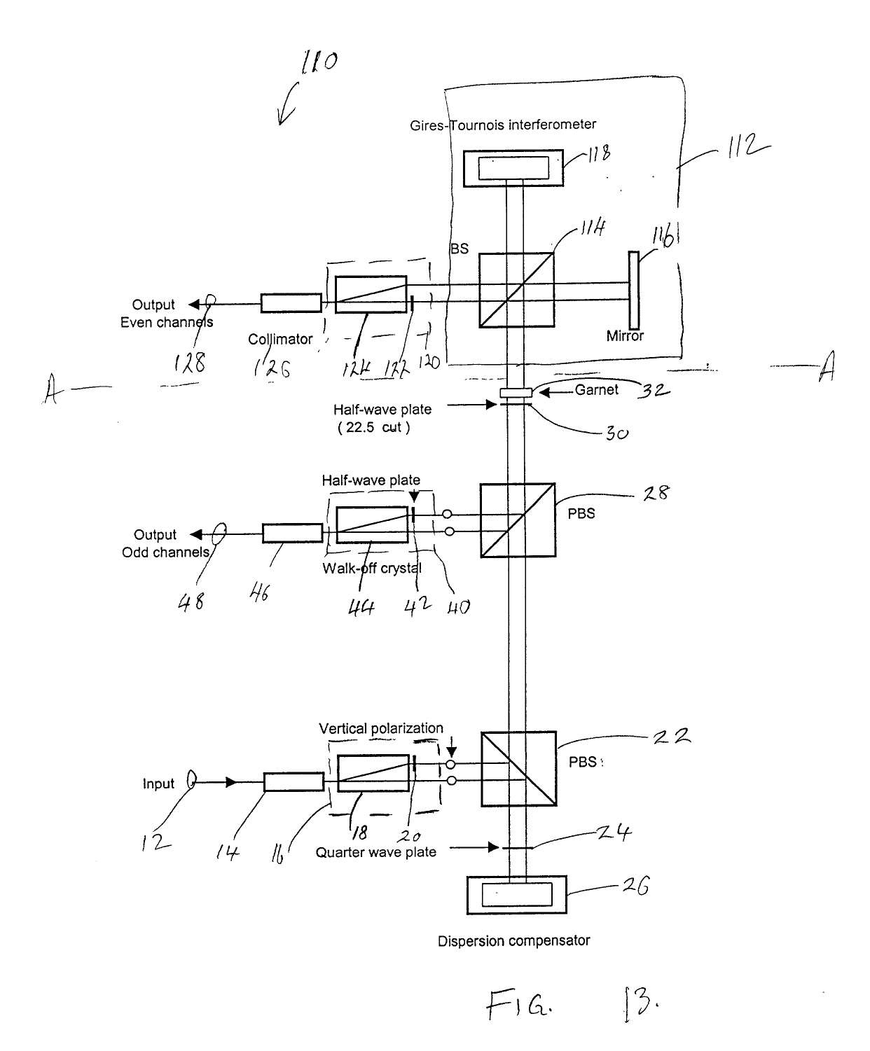

FIG. 12 shows an interleaver that has the same elements as the deinterleaver of FIG. Except for the garnet 32 as indicated by the facet 33.which has the “A” face facing the quarter wave plate 30

FIG.13 shows a schematic of a second dispersion compensated deinterleaver in accordance with the present invention. Numeral identifiers used in FIG. 3 are used again in FIG. 13 to identify like elements. All of the parts shown below the dashed line AA in FIG. 13 have like numbered counterparts in FIG. 3. Therefore, the description of the deinterleaver 110 can conveniently begin at the point where the horizontally polarized input signal leaves the garnet 32 and enters the interferometer section 112. The interferometer section 112 includes a 50/50 beam splitter 114 optically coupled to the garnet 32, optically coupled to a reflecting mirror 116 and optically coupled to an interferometer 118. The beam splitter 114 splits the horizontally polarized input signal into a portion which is reflected by the mirror 116 back to the beam splitter 114, and a portion which is reflected by the interferometer 118 back to the beam splitter 114.

The combination of the Gires-Tournois interferometer 118 with the beam splitter 114 and the mirror 116, is a Gires-Tournois-Michelson interferometer (GTMI). The Gires-Tournois interferometer 118 is shown, in cross-section in FIG. 4.

The signals reflected from the mirror 116 and from the Gires-Tournois interferometer 118 go back to the beam splitter 114 and interfere within the beam splitter 114 so that the beam splitter 144 outputs a horizontally polarized signal containing the set of odd channels (horizontally polarized odd channel signal) to the garnet 32 and outputs a horizontally polarized signal containing the set of even channels (horizontally polarized even channel signal) to the translator 120.

The horizontally polarized odd channel signal passes through the garnet 32 which rotates the polarization through forty five degrees. The signal then passes through the 22.5° cut half-wave plate 30 which rotates the polarization through an additional forty five degrees so that the signal becomes a vertically polarized odd channel signal. As described with regard to FIG. 3 this signal is reflected in polarization beam splitter 28 and is depolarized in translator 40 which sends the odd channel output signal via collimator 46 to output port 48.

The horizontally polarized even channel signal goes from the beam splitter 114 to translator 120. The translator 120 includes a half-wave plate 122 and a walk-off crystal 124. Part of the horizontally polarized even channel signal enters the walk-off crystal 124 directly and part passes through the half-wave plate 122, where it becomes vertically polarized, before entering the walk-off crystal 124. Both parts of the signal are recombined in the walk-off crystal 124 to form a depolarized signal that is the even channel output signal which passes through the collimator 126 to input/output port 128. The dispersion of a 50 GHz dispersion compensated GTMI based interleaver is calculated to be +/−10 ps/nm as compared to +/−50 ps/nm calculated for a GTMI interleaver without dispersion compensation.

The above described embodiments of the invention are to be regarded as illustrative of the invention are not intended to be construed as limiting. Accordingly the scope of the invention should be determined by the following claims and their legal equivalents.

What is claimed is

1. A dispersion compensated apparatus for performing one of the two functions of an interleaver/deinterleaver comprising:
a signal processing interferometer; and
a dispersion compensating interferometer, optically coupled to the signal processing interferometer, for compensating the chromatic dispersion of the signal processing interferometer.

2. The apparatus of claim 1 wherein essentially all the light in the output signals has been through the signal processing interferometer and through the dispersion compensating interferometer.

3. The apparatus of claim 1 wherein the dispersion compensating interferometer is a GTI interferometer.

4. The apparatus of claim 3 wherein the signal processing interferometer is a GTI based interferometer.

5. The apparatus of claim 4 wherein the GTI based interferometer is a NLI interferometer.

6. The apparatus of claim 5 wherein the NLI interferometer is a GTI interferometer comprising a cavity between parallel mirrors, one mirror being approximately 100% reflective and the other mirror being partially reflective with a λ/4 wave-plate in the cavity and an external λ/8 wave-plate external to the cavity.

7. The apparatus of claim 6 further comprising a unidirectional optical component located in the optical path between the signal processing interferometer and the dispersion compensating interferometer wherein the unidirectional optical component is oriented to make the apparatus an interleaver.

8. The apparatus of claim 7 wherein the unidirectional component is a combination of half-wave plate and garnet, located on the optical path between the signal processing interferometer and the dispersion compensating interferometer, and oriented with the half-wave plate towards the signal processing interferometer.

9. The apparatus of claim 6 wherein the unidirectional optical component is oriented to make the apparatus a deinterleaver.

10. The apparatus of claim 9 wherein the unidirectional optical component is a combination of half-wave plate and garnet, located in the optical path between the dispersion compensating interferometer and the signal processing interferometer, and oriented with the garnet towards the signal processing interferometer.

11. The apparatus of claim 4 wherein the GTI based interferometer is a GTMI interferometer.

12. The apparatus of claim 11 wherein the GTMI comprises a Michelson interferometer including a 50/50 beam splitter, a first mirror, and a GTI in place of a mirror.

13. The apparatus of claim 11 wherein the unidirectional optical component is oriented to make the apparatus an interleaver.

14. The apparatus of claim 12 wherein the unidirectional component is a combination of a half-wave plate and a garnet, located on the optical path between the signal processing interferometer and the dispersion compensating interferometer, and oriented with half-wave plate towards the signal processing interferometer.

15. The apparatus of claim 11 wherein the unidirectional optical component is oriented to make the apparatus a deinterleaver.

16. The apparatus of claim 15 wherein the unidirectional optical component is a combination of half-wave plate and garnet, located in the optical path between the signal processing interferometer and the dispersion compensating interferometer, and oriented with the garnet towards the signal processing interferometer.

17. A method for deinterleaving an optical signal containing a set of even channels and a set of odd channels, the method comprising:
inputting the optical signal at an input port of a deinterleaver;
linearly polarizing the optical signal;
passing the polarized optical signal through a dispersion compensating GTI interferometer;
applying the polarized input signal to a signal processing interferometer to obtain an odd channel polarized signal and an even channel polarized signal;
depolarizing the odd channel signal; and
depolarizing the even channel signal.
